(19) United States
(12) Patent Application Publication
(10) Pub. No.: US 2026/0268767 A1
(43) Pub. Date: Sep. 10, 2026

(54) REAL-TIME VEHICLE TRACKING AND MOVEMENT MANAGEMENT AND CONTROL

(71) Applicant: MOTIVE TECHNOLOGIES, INC., San Francisco, CA (US)

(72) Inventors: Jason PESEK, Orlando, FL (US); Atif SAFEER, Vancouver (CA); Michael MARSELLA, Guelph (CA); Qian WU, Markham (CA); Dayanand Paruvai RAMASAMY, Sulur (IN); Madhurdeep SINGH, Kitchener (CA); Birapuram Kumar REDDY, Orvakal (IN)

(21) Appl. No.: 19/074,730

(22) Filed: Mar. 10, 2025

(51) Int. Cl. G08G 1/0967; B60K 35/28; G06Q 10/0631

(52) U.S. Cl. CPC G08G 1/096725; B60K 35/28; G06Q 10/063114

(57) ABSTRACT

Disclosed are systems and methods that provide a scalable, decision intelligence (DI)-based computerized framework for performing real-time vehicle fleet management and control. The framework function to provide real-time fleet management via context-based and/or event-driven technological solutions for customizable, context-aware operational instructions with intelligent triggers and dynamic task progression, such that vehicle fleets can be monitored and/or managed for accurate and efficient resource usage in task completion. The framework provides computerized capabilities for dynamic and/or automatic computerized operations that reduce resource overhead and minimize operational risks, while providing functionality for vehicle fleets'on-time, and safe and secure performance in real-time.

### FIELD OF THE DISCLOSURE

The present disclosure relates to electronic vehicle fleet management, and more particularly, to a decision intelligence (DI)-based computerized framework for dynamically and/or automatically managing and controlling real-world equipment.

### SUMMARY OF THE DISCLOSURE

Fleet management systems currently face significant technical challenges in ensuring comprehensive task adherence and procedural compliance for remote field workers. The existing technological landscape reveals critical architectural and operational limitations that fundamentally undermine operational efficiency and regulatory compliance.

One technical deficiency lies in the fragmented user interface (UI) design of current fleet management platforms. These systems typically require field workers to navigate multiple complex screen interfaces and disparate system sections to complete individual tasks. Such fragmented interaction models introduce substantial cognitive load and increase the probability of procedural errors. The complex navigation paths create significant friction in task completion, directly translating to increased administrative overhead and reduced operational responsiveness.

Workflow customization represents another profound technical limitation. Existing solutions demonstrate rigid architectural frameworks that cannot dynamically adapt to specific fleet operational requirements. This inflexibility manifests in generic, non-contextual task prompting mechanisms that fail to align with nuanced field worker workflows. The resultant system becomes fundamentally misaligned with real-world operational dynamics, creating a technological disconnect between administrative intent and field execution capabilities.

Furthermore, critical time-sensitive compliance tasks—such as Hours of Service (HOS) documentation for electronic logging devices (ELDs) and comprehensive vehicle maintenance inspections—are particularly vulnerable to these systemic technical constraints. The lack of intelligent, event-driven workflow engines means that compliance-critical tasks are often executed inconsistently or belatedly, exposing organizations to significant regulatory and safety risks.

Moreover, communication synchronization between field workers and back-office systems represents another substantial technical challenge. Current technological approaches struggle to create real-time, context-aware communication channels that can effectively coordinate complex operational procedures. Such synchronization deficit results in delayed information propagation, reduced operational visibility, and increased potential for procedural gaps.

Conventional technical architectures used and/or implemented by/within existing fleet management systems typically rely on static, predetermined workflow models that cannot rapidly adapt to dynamic operational environments. Such rigidity prevents organizations from implementing agile, context-sensitive task management strategies that could significantly enhance operational responsiveness and compliance effectiveness.

Accordingly, such multifaceted technical limitations underscore the critical need for a fundamentally reimagined technological approach to fleet management workflow systems—one that prioritizes adaptive, user-centric design, intelligent event-driven processing, and seamless cross-platform communication capabilities.

To that end, according to some embodiments, the disclosed systems and methods address such technical shortcomings, among others, by providing a computerized framework for the curation of dynamic workflows that control and/or manage how equipment (e.g., vehicles, for example) function and/or operate. As discussed herein, in some embodiments, the disclosed framework provides event-driven trigger mechanisms that provides capabilities for context-aware task initiation and progression. By implementing intelligent triggers, the disclosed framework can automatically prompt and guide drivers through complex, multi-step procedural requirements with improved precision. In some embodiments, such event-driven mechanisms or triggers can be configured to activate based on, but not limited to, specific operational conditions, vehicle states, temporal parameters, predefined compliance checkpoints, geofencing, collision detection, user (e.g., driver) identity (ID), vehicle type, task type, time, date, location, and the like, or some combination thereof.

According to some embodiments, the disclosed framework can operate via a template builder architecture that provides capabilities for intricate workflow design, including optional steps, mandatory actions, and critical lock points that prevent premature task completion and/or system progression. Such adaptive approach can ensure, for example, that drivers cannot advance through critical operational sequences without satisfying prerequisite compliance and safety requirements. Indeed, such architectural flexibility provides capabilities to fleet administrators to create highly customized, industry-specific workflow templates that reflect their unique operational ecosystem.

In some embodiments, the disclosed framework can provide in-app restriction mechanisms that can serve as technological safeguards that can dynamically constrain driver actions. For example, as provided below, the disclosed framework can be embodied via an application running on a user device, on a network device, at a network node, on the cloud, and the like, or some combination thereof (e.g., see FIG. 1, infra), whereby intelligent (or “smart”) restrictions can function to provide not only passive barriers to content access (e.g., next task within the workflow), but as active guidance systems that provide contextual instructions that can prevent potential procedural deviations in real-time, as discussed herein.

According to some embodiments, the framework can be configured to provide seamless integration with existing fleet management systems, allowing organizations to enhance their technological infrastructure without complete systemic replacement. By leveraging event-driven architecture, the solution offers a responsive, adaptive approach to operational workflow management that can dynamically adjust to changing regulatory landscapes and organizational requirements.

As discussed herein, the disclosed systems and methods provide non-native functionality to existing systems and devices operating therein for, but not limited to, intelligent task sequencing, automated compliance verification, contextual user guidance, comprehensive audit trail generation, and the like. For example, in some embodiments, the framework can function to transform traditional linear workflow models into an adaptive process network operation that can intelligently detect and respond to complex operational scenarios while maintaining rigorous safety and compliance standards. As evidenced from the instant disclosure, such innovative approach fundamentally reimagines fleet management workflow systems by treating operational procedures as dynamic, intelligent ecosystems rather than static, inflexible process chains. The result is a technological solution that dramatically reduces administrative overhead, minimizes compliance risks, and enhances overall operational efficiency through intelligent, automated workflow management.

According to some embodiments, a method is disclosed for an DI-based computerized framework for dynamically and/or automatically managing and controlling real-world equipment. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for dynamically and/or automatically managing and controlling real-world equipment.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub- networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. As discussed herein, according to some embodiments, the disclosed framework operates to provide a comprehensive workflow management solution for fleet operations that dynamically adapts to complex operational requirements to create digital and/or electronic context-aware workflows that automatically initiate and progress based on specific triggers and operational conditions.

According to some embodiments, the framework can leverage multiple trigger mechanisms to dynamically launch workflows, including shift-based events, geofence entry points, temporal parameters, and the like. Thus, for example, when a driver begins their shift, the framework can automatically calculate start times using, for example, Hours of Service (HOS) data, initiating predefined workflow sequences. For example, HOS data for a vehicle within a fleet can be strategically analyzed to determine optimal workflow presentation times. By examining patterns of driver activity and rest periods, the framework can identify windows when drivers are most receptive to new information—typically at the beginning of shifts when drivers are alert, during scheduled breaks when they have mental bandwidth, or after completing tasks when immediate pressure is reduced, for example. HOS data also reveals vehicle downtime patterns that can be utilized for presenting non-critical workflows without disrupting operations. Additionally, compliance status information indicates when drivers have sufficient duty hours remaining to complete any proposed tasks, ensuring workflows are not introduced when time constraints would create undue stress or potential regulatory violations.

Similarly, geofence-based triggers can activate location-specific procedures, ensuring that drivers follow precise protocols when entering designated operational areas. By way of example, in some embodiments, geofencing APIs can be utilized by the framework for the creation of virtual boundaries that monitor vehicle movements in real-time. When integrated with telematics systems, such APIs trigger automated actions and notifications whenever vehicles cross predefined geographic perimeters. Such technology enables precise tracking of arrivals and departures at customer sites, alerts for unauthorized area access, detection of route deviations, and monitoring of dwell times at specific locations. The framework can establish time-sensitive boundaries, restricted zones, and proximity alerts that enhance operational efficiency and security. The data collected through geofencing also provides valuable insights for route optimization, productivity analysis, compliance verification, and automated customer communications, all while reducing the administrative burden of manual location monitoring, as discussed herein.

Moreover, for example, a trigger tied to collision detection of a vehicle can cause routing or re-routing of vehicles in the fleet, as provided below respective to the workflow determinations and implementations. For example, if a vehicle is in an accident, another vehicle can be routed to complete the route of the other vehicle starting from a point of the collision. This ensures efficient and accurate workflow completion, with minimal resource expenditure and risk.

According to some embodiments, the framework can operate to construct each workflow using configurable actions that can be designated as either required or optional. Such flexible design allows the framework to create nuanced procedural frameworks for fleet managers (e.g., fleet controller) that maintain critical compliance requirements while providing adaptability for diverse operational scenarios. Required actions ensure essential tasks are completed, while optional steps accommodate variability in field worker responsibilities.

As discussed herein, such workflows can be configured as, but not limited to, data structures, files, and/or any other type of set of executable logic that enables a processor, computer, API, device, and the like, to execute and/or receive instructions for guiding how a vehicle(s) can function (e.g., where, when and/or how (e.g., route) a vehicle can proceed along a determined route, for example). Accordingly, as discussed herein, such automatically and/or dynamically determined workflows can integrate shift start and end detection operations, geolocation services, and/or intelligent task sequencing to provide responsive operational environments that adapt to changing field conditions while maintaining consistent procedural standards. For example, drivers may be restricted from going on duty until they complete mandatory vehicle inspections or review critical safety protocols. Thus, the framework can, for example, provide programmatic checkpoints that enforce rigorous compliance and safety standards by creating a sequential, controlled progression through operational tasks.

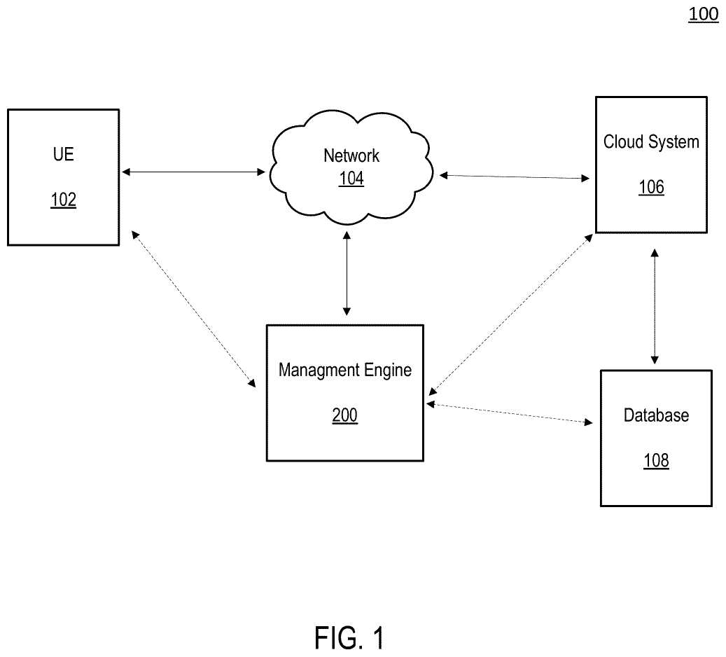

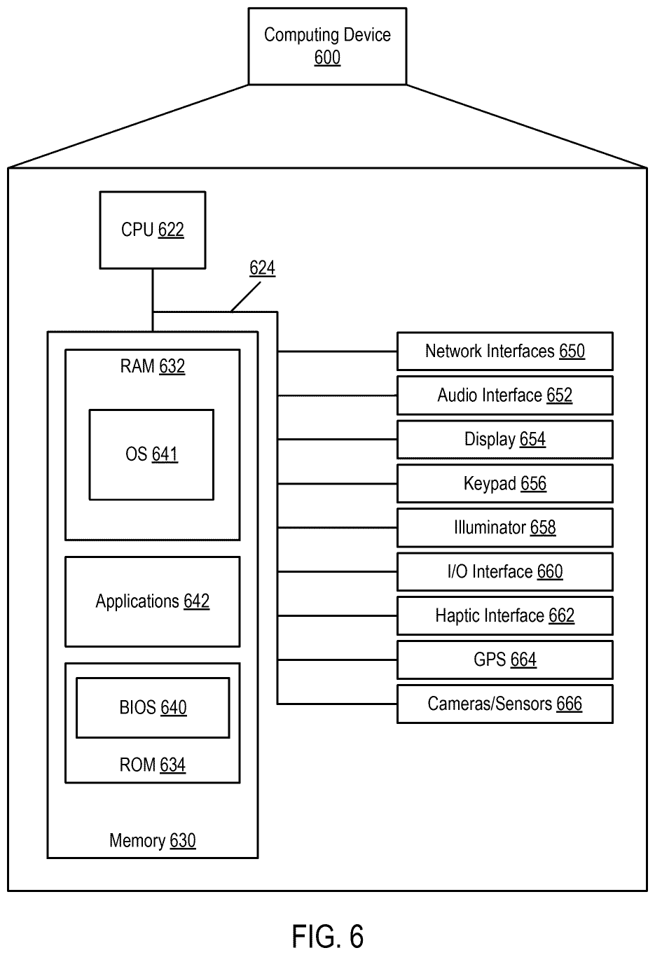

With reference to FIG. 1, system 100 is depicted which includes user equipment (UE) 102 (e.g., a client device, as mentioned above and discussed below in relation to FIG. 6), network 104, cloud system 106, database 108, and management engine 200. It should be understood that while system 100 is depicted as including such components, it should not be construed as limiting, as one of ordinary skill in the art would readily understand that varying numbers of UEs, peripheral devices, cloud systems, databases, network resources, engines and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, Internet of Things (IoT) device, autonomous machine, and any other device equipped with a cellular or wireless or wired transceiver. For example, UE 102 can be a mobile device of a user driver that is associated with a vehicle within a fleet (e.g., driver Bob is assigned to drive vehicle X). In another non-limiting example, UE 102 can be a vehicle that is part of a set of vehicles (e.g., a fleet) that is being driven by an assigned driver.

In some embodiments, a peripheral device (not shown) can be associated with and/or connected to UE 102, and can be any type of peripheral device, such as, but not limited to, a mobile device, wearable device (e.g., smart watch), printer, speaker, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like. For example, as per an above example, a peripheral device can be a device of a user that is driving vehicle (UE) 102.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a network and/or electronic fleet management platform, which has associated network resources hosted on the internet or private network (e.g., network 104), which enables (via engine 200) the monitoring, tracking and guidance functionality and capabilities discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE, and the services and applications provided by cloud system 106 and/or management engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

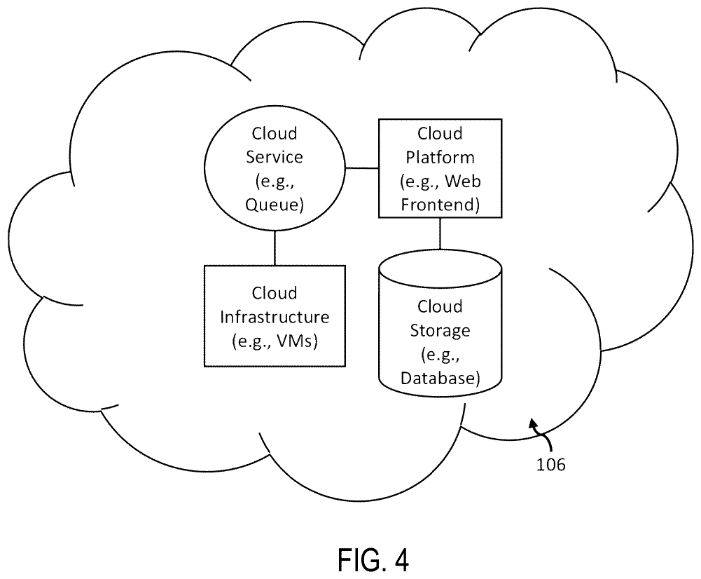

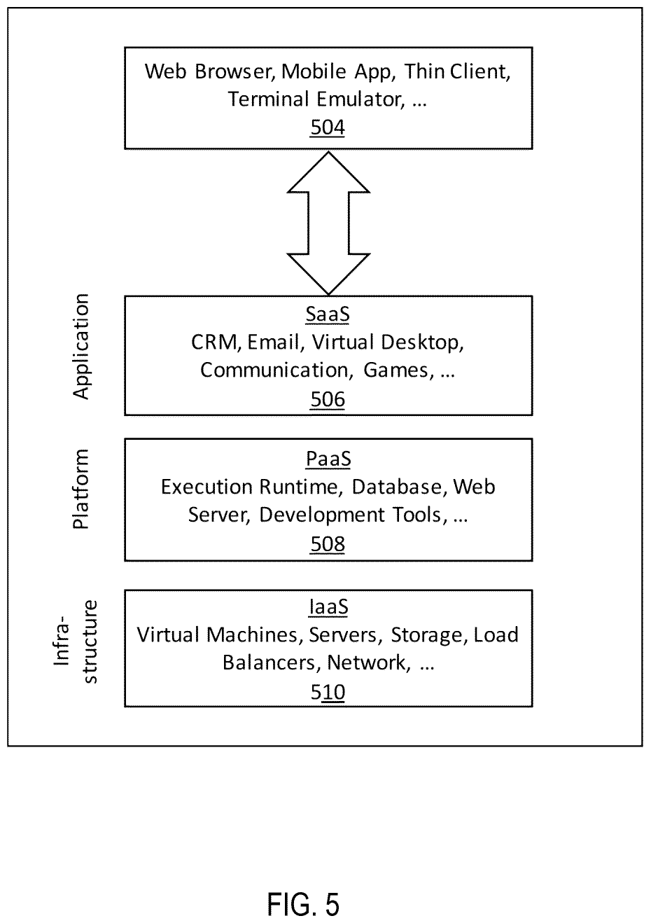

Turning to FIG. 4 and FIG. 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIG. 4 and FIG. 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Management engine 200, as discussed above and further below in more detail, can include components for the disclosed functionality. According to some embodiments, management engine 200 may be a special purpose machine or processor, and can be hosted by a device on network 104, within cloud system 106, and/or on UE 102. In some embodiments, engine 200 may be hosted by a server and/or set of servers associated with cloud system 106.

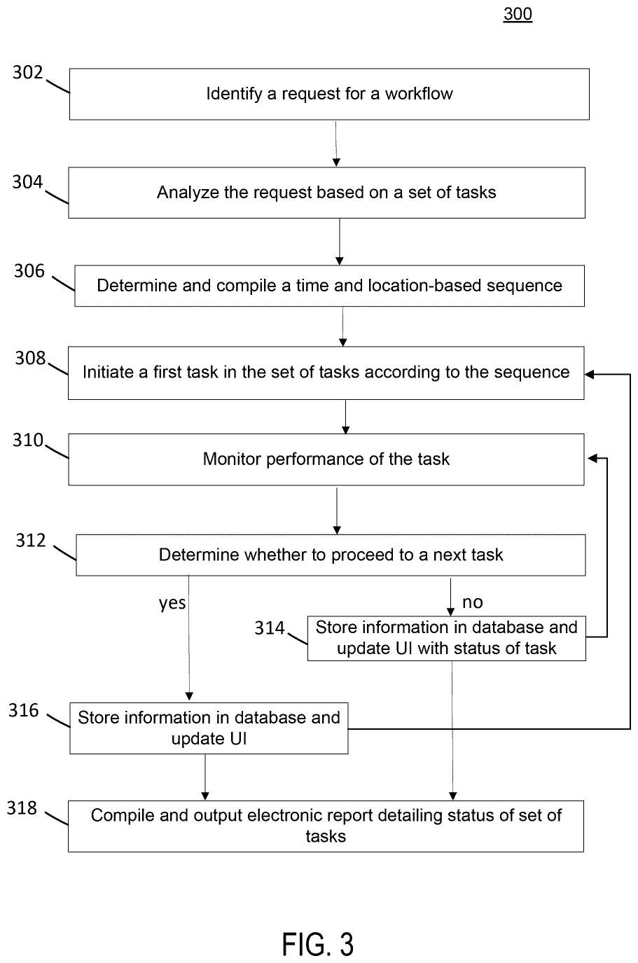

According to some embodiments, as discussed in more detail below, management engine 200 may be configured to implement and/or control a plurality of services and/or microservices, where each of the plurality of services/microservices are configured to execute a plurality of workflows associated with performing the disclosed search functionality. Non-limiting embodiments of such workflows are provided below in relation to at least FIG. 3.

According to some embodiments, as discussed above, management engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102. In some embodiments, such application may be a web-based application accessed by UE 102 over network 104 from cloud system 106. In some embodiments, engine 200 may be configured and/or installed as an augmenting script, program or application (e.g., a plug-in or extension) to another application or program provided by cloud system 106 and/or executing on UE 102.

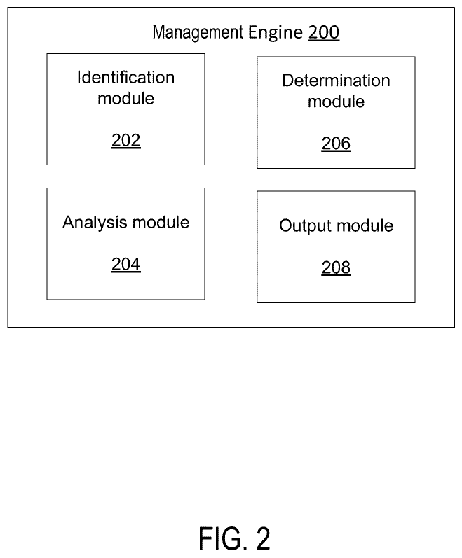

As illustrated in FIG. 2, according to some embodiments, management engine 200 includes identification module 202, analysis module 204, determination module 206 and output module 206. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below. Management engine 200 or other device(s) running Process 300 may be operated entirely at the user device level, or with cloud support as a distributed system, or at a service provider's infrastructure, as non-limiting implementation examples. It will be understood that the disclosure herein provides for a configuration that is platform agnostic and may be operated on multiple alternative platforms as a matter of design choice using the teachings described.

Accordingly, in some embodiments, as provided herein (e.g., discussed with reference to FIGS. 1-2, supra), the disclosed framework can function as part of a telematics system for fleet management that integrates vehicle-based data collection mechanisms with cloud-based analytics and controls to optimize fleet operations in real-time.

In some embodiments, for example, at the vehicle level (e.g., UE 102), each vehicle can be equipped with a telematics control unit (TCU) that combines GPS tracking, cellular connectivity, and various sensors to monitor critical vehicle parameters (e.g., camera, attention, location, gasoline, oil, and the like, for example). The TCU collects data including vehicle location, speed, fuel consumption, engine diagnostics, driver behavior metrics (like harsh braking or rapid acceleration), and vehicle status information. This data is continuously transmitted via cellular networks to the cloud-based fleet management platform.

In some embodiments, for example, the cloud 106 can perform operations to process incoming data streams from all connected vehicles in real-time. As discussed in more detail below, such operations can implement computerized algorithms and/or models to analyze the aggregated data and provide actionable insights for fleet operators. The framework can automatically optimize route planning based on current traffic conditions, vehicle availability, and delivery schedules. The framework, in some embodiments, can also predict maintenance needs by analyzing engine diagnostic data and vehicle usage patterns, allowing for proactive maintenance scheduling that minimizes vehicle downtime.

In some embodiments, for dynamic fleet management, the cloud platform can function to enable real-time decision-making and fleet optimization. For example, when new service requests or deliveries come in, the framework can automatically assign the most suitable vehicle based on factors like current location, fuel levels, driver hours, and vehicle capacity. The framework can also adapt to unexpected events such as traffic delays or vehicle breakdowns by dynamically re-routing vehicles and reassigning tasks to maintain service levels. Indeed, fleet managers can access this information through web-based dashboards and mobile applications, allowing them to monitor fleet performance, receive alerts about critical events, and make informed decisions about fleet operations. Such real-time visibility and control helps organizations improve operational efficiency, reduce fuel consumption, enhance driver safety, and ultimately deliver better service to their customers.

Turning to FIG. 3, Process 300 provides non-limiting example embodiments for a DI-based computerized framework for dynamically and/or automatically managing and controlling real-world equipment (e.g., performing electronically determined and controlled management of vehicle movements, actions, tasks, and the like, as part of an overall management and monitoring of a fleet of vehicles).

As discussed herein, according to some embodiments, the disclosed fleet management framework provides an innovative approach to driver compliance and operational efficiency. The framework addresses critical industry challenges by automating task management and ensuring comprehensive procedural adherence.

According to some embodiments, the framework's functionality can provide capabilities for start-of-day workflows, end-of-day procedures, and geofence-triggered processes. In some embodiments, by way of example, during the start of the day (or at specific/preset time, for example), drivers are required to complete a series of mandatory tasks before being permitted to commence driving. This includes, for example, vehicle and trailer inspections, document preparation, and log form completion. The framework can strategically block and/or grant access to essential driving functions until such critical compliance steps are satisfied.

In some embodiments, the framework can implement “lock points” (e.g., read/write access controls to application functionality, for example) as operational mechanisms that can prevent drivers from accessing non-critical application features until specific workflow steps are completed. This approach ensures that drivers systematically complete required tasks in a precise order, thereby dramatically reducing the administrative burden on fleet managers who previously had to manually track compliance.

In some embodiments, geofence-based workflows can provide an additional layer of contextual task management. For example, when a driver enters specific geographic areas, such as different warehouse locations for example, the framework can automatically trigger location-specific workflows. These may include, for example, trailer exchanges, documentation updates, and required inspections specific to the particular operational context.

Accordingly, as discussed herein, workflows can be based on, but not limited to, time, location, event type, tasks, lock points, driver ID, requirements (e.g., compliance, regulations, and the like), and the like, or some combination thereof.

Moreover, as discussed herein, the disclosed framework's operation can cause, provide instructions related to and/or trigger types of real-world vehicle movements and/or non-movements. According to some embodiments, the disclosed framework can function to provide a vehicle control mechanisms via integration between a vehicle's vehicle gateways (VG) and driver application, thereby creating a comprehensive command chain that influences real-world vehicle movements. The VG, which can be for a single or set of vehicles, serves as the critical hardware interface connecting to the vehicle's control area network (CAN) bus network, enabling/permitting direct communication with essential control modules including engine management, braking systems, door locks, and the like. Thus, for example, when fleet management software issues an instruction, it travels through cellular or satellite networks to the VG, which translates these commands into vehicle-specific protocols. The driver app complements this system by providing authentication through biometrics or credentials before permitting vehicle operation, effectively controlling access permissions. For performance management, the VG can implement speed governors, geofence-based restrictions, or engine parameter adjustments based on real-time conditions or preset policies. During operation, telematics data flows back through this same pathway, enabling dynamic response to changing situations. This bidirectional communication allows for immediate intervention during safety concerns, such as remotely reducing acceleration capability if erratic driving is detected, or gradually limiting functionality if unauthorized usage occurs. The system can also enforce compliance by restricting vehicle operation during mandated rest periods or preventing engine start when maintenance is overdue, ensuring that fleet policies are physically implemented.

According to some embodiments, in low-connectivity environments or offline scenarios, the disclosed fleet management framework can implement fallback mechanisms that maintain critical vehicle control functionality despite communication challenges. The framework can employ a layered architecture where the VG contains locally stored rule sets and configuration policies that remain operational when cloud connectivity is interrupted. The VG can continuously cache critical operational parameters, geofence boundaries, authorization credentials, and vehicle restriction profiles directly in secure onboard memory, allowing it to enforce fleet policies autonomously without requiring constant server communication. Similarly, driver applications are designed with offline capabilities, locally storing authentication credentials and operation permissions that synchronize with the VG through short-range protocols like Bluetooth or Wi-Fi Direct when cellular networks are unavailable. This creates a self-contained authorization ecosystem that maintains security protocols even in remote areas.

For extended offline operation, the framework can implement progressive degradation strategies rather than complete functionality loss. For example, the VG's onboard processor can continue to monitor vehicle behavior against stored parameters, maintaining geofence enforcement through GPS satellites (which operate independently from cellular networks) and implementing predetermined contingency protocols when violations occur. Scheduled permission updates and time-based restrictions function through locally stored calendars with precise time tracking maintained by the VG's internal clock, preventing exploitation of communication gaps. To preserve data continuity, the framework can store telemetry information and event logs in compressed formats within local storage, implementing sophisticated queue management that prioritizes critical security events and compliance data for transmission once connectivity is re-established.

In some embodiments, the framework can utilize or incorporate mesh networking capabilities where multiple vehicles within proximity can share essential updates and alert information through vehicle-to-vehicle communication protocols, extending effective coverage areas. This creates resilient information islands that propagate critical updates when any single vehicle regains connectivity. Additionally, the VG and driver application can employ predictive preloading of likely needed permissions and instructions based on historical patterns and scheduled assignments before entering known dead zones. In some embodiments, the framework can incorporate buffer periods for time-sensitive restrictions, preventing immediate lockouts due to connectivity failures, while maintaining clear operator notifications about the system's current operating status and connectivity state. Upon reconnection, synchronization operations can be performed to ensure the data is synchronized, and updated across the network on each involved node. Through these layered redundancies and localized decision-making capabilities, the disclosed fleet management framework can maintain effective vehicle control even when operating in the most challenging communication environments, ensuring safety and policy compliance regardless of connectivity status.

According to some embodiments, Step 302 of Process 300 can be performed by identification module 202 of management engine 200; Steps 304 and 310 can be performed by analysis module 204; Steps 306 and 312 can be performed by determination module 206; and Steps 308 and 314-318 can be performed by output module 208.

According to some embodiments, Process 300 begins with Step 302 where engine 200 can identify a request for a workflow. As discussed herein, engine 200 is designed to identify requests for workflows within the fleet management system, ensuring that operations run smoothly and efficiently. In a fleet environment, a workflow request may arise from a variety of sources, including the initiation of a driver's shift, a scheduled maintenance check, or a specific task required for compliance.

According to some embodiments, engine 200 can continuously monitor incoming requests and evaluate their urgency, dependencies and required actions (e.g., set of tasks). In some embodiments, such operations can involve the processing of structured and unstructured data such as driver schedules, vehicle health metrics, GPS data, historical task logs, and the like. By leveraging a customizable mobile workflow engine, engine 200 can automatically generate workflows tailored to fleet-specific needs, ensuring that all necessary steps are followed, as discussed infra.

In Step 304, engine 200 can function to analyze the request based on a set of tasks (e.g., a job request or route with a series of stops, for example). That is, once a workflow request is received/identified, engine 200 can perform operations to analyze the request in view of (e.g., based on or against) a predefined set of criteria that determines the workflow's relevance and sequence. Such analysis involves checking operational parameters such as, but not limited to, driver status, vehicle readiness, geographic location, compliance mandates, and the like.

In some embodiments, such analysis can be based on, but not limited to, historical fleet data, active telematics feeds, regulatory compliance rules, pre-configured fleet-specific task dependencies, and the like, to determine the appropriateness of generating and/or initiating a particular workflow.

In some embodiments, the computational analysis performed in Step 304 can involve engine 200 calling and executing an artificial intelligence and/or machine learning (AI/ML) and/or LLM model. Accordingly, in some embodiments, the AI/ML models can be any type of known or to be known, specifically trained AI/ML model, particular machine learning model architecture, particular machine learning model type (e.g., convolutional neural network (CNN), recurrent neural network (RNN), autoencoder, support vector machine (SVM), and the like), or any other suitable definition of an AI/ML model or any suitable combination thereof.

In some embodiments, an LLM can be leveraged, as discussed herein, whether known or to be known. As discussed above, an LLM is a type of AI system designed to understand and generate human-like text based on the input it receives. The LLM can implement technology that involves deep learning, training data and NLP. Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, such model can be configured to identify and utilize one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique can be one of, without limitation, feedforward neural network, radial basis function network, recurrent neural network, convolutional network (e.g., U-net) or other suitable network. In some embodiments and, optionally, in combination of any embodiment described above or below, an implementation of Neural Network can be executed as follows:
a. define Neural Network architecture/model,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained neural network model can specify a neural network by at least a neural network topology, a series of activation functions, and connection weights. For example, the topology of a neural network can include a configuration of nodes of the neural network and connections between such nodes. In some embodiments and, optionally, in combination of any embodiment described above or below, the trained neural network model can also be specified to include other parameters, including but not limited to, bias values/functions and/or aggregation functions. For example, an activation function of a node can be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function can be a mathematical function that combines (e.g., sum, product, and the like) input signals to the node. In some embodiments and, optionally, in combination of any embodiment described above or below, an output of the aggregation function can be used as input to the activation function. In some embodiments and, optionally, in combination of any embodiment described above or below, the bias can be a constant value or function that can be used by the aggregation function and/or the activation function to make the node more or less likely to be activated.

In some embodiments, if/when multiple workflow requests are received (or exist-e.g., they are received in order, simultaneously and/or in an overlapping manner, for example), engine 200 can function to prioritize them based on urgency and dependencies, ensuring high-priority tasks are addressed first. Accordingly, in some embodiments, AI/ML models can be utilized to predict potential workflow adjustments based on past operational data, thereby reducing inefficiencies and ensuring that tasks are performed in the most optimal order.

In Step 306, based on the analysis discussed above in Step 304, engine 200 can determine then compile (or generate or create) a time-based and/or location-based sequence for executing the set of tasks. Such sequence can be a workflow, as discussed above, which can be a data structure and/or any other type of executable file that controls access to the set of tasks, and in some embodiments, can control operation of a vehicle (e.g., vehicle can be turn off or prohibited from moving to another location-e.g., turn off ignition, for example). According to some embodiments, such determination/compilation can involve aggregation and processing of GPS coordinates, driver shift patterns, vehicle movement data, and other geospatial datasets to ensure accurate sequencing. Accordingly, in some embodiments, the curated workflow can be structured based on real-time data, including, but not limited to, driver schedules, vehicle type, fleet operation timelines, geographic constraints, and the like. For example, if a driver is scheduled to pick up cargo at a specific location, engine 200 can function to ensure that prerequisite tasks, such as vehicle inspections or document verification, are completed in advance. Accordingly, engine 200's ability to dynamically adjust workflows based on real-time conditions ensures that operations remain adaptive and responsive, minimizing downtime and enhancing productivity.

According to some embodiments, as discussed herein, the framework (engine 200) can function and/or cause operations associated with an intermediary layer between a vehicle's systems, the task management application, and the driver interface, implementing both software and hardware-level controls to ensure task compliance. In some embodiments, engine 200 can maintain a state machine that tracks the current task status and applies corresponding access restrictions through a combination of application-level permissions and vehicle control unit interventions.

In some embodiments, for application-level control, engine 200 can implement a secure middleware that intercepts all read and write operations to the task list data store. For example, when the driver attempts to access the task management application, engine 200 can validate their current task status before granting or denying access. This can be accomplished through a custom security provider that wraps the application's native data access methods. In some embodiments, engine 200 can function to only allow read access to the current active task details and maintains write-only access for task completion confirmations. In some embodiments, future tasks may remain encrypted and inaccessible until the current task is marked as complete through proper verification channels.

In some embodiments, engine 200 can extend control beyond the application layer to vehicle operations, in that engine 200 can integrate with the vehicle's CAN bus and electronic control units through a specialized interface module. Such module translates high-level task state requirements into specific vehicle control parameters. For example, when a task requires the vehicle to remain at a specific location, engine 200 can engage the electronic parking brake, limit engine RPM, or restrict gear selection through direct CAN bus commands. Such non-native control functions are implemented as a separate security layer that operates independently from the vehicle's standard operational systems.

As discussed herein, in some embodiments, engine 200 includes a geofencing component that continuously monitors the vehicle's GPS coordinates against the approved task route or location parameters. Thus, if the vehicle deviates from the authorized path or attempts to operate outside of task boundaries, engine 200 can automatically intervene through graduated response measures. Such operational controls can range from initial warning notifications to the driver, to actively limiting vehicle speed, to ultimately initiating a safe shutdown sequence if necessary.

Accordingly, in some embodiments, to ensure system integrity and prevent unauthorized circumvention, engine 200 can implement a secure boot process and continuous runtime validation. Control modules can be signed with cryptographic keys, and communication between components is encrypted. Accordingly, the framework, as discussed herein, can maintain a secure audit log of all access attempts and control interventions, which can be reviewed by fleet managers (fleet controllers) for compliance verification.

Thus, as discussed herein, engine 200's architecture is configured to be extensible, allowing for the integration of additional control mechanisms as needed. For example, this can include driver monitoring systems, additional vehicle subsystem controls, integration with external fleet management platforms, and the like.

In some embodiments, the information determined from Steps 306 can be stored in database 108, as discussed above.

In Step 308, engine 200 can operate to initiate a first task in the set of tasks according to the determined sequence. According to some embodiments, once the workflow sequence is defined, engine 200 initiates the first task by displaying a user interface (UI) to the driver and/or fleet administrator. In some embodiments, as discussed above, the UI can provide interactive, secured step-by-step instructions, ensuring the viewer (e.g., driver) understands the required actions. This interaction could involve selecting a vehicle, confirming duty status and/or conducting a pre-trip inspection. Engine 200 can function to ensure that the UI dynamically updates based on real-time task completion data (e.g., provide next task, and/or restrict access to next task until the current task is completed, as discussed below) Engine 200 also integrates with onboard vehicle diagnostics and telematics systems to verify completion. If a pre-trip inspection requires a tire pressure check, engine 200 can cross-reference vehicle sensors to confirm the action. Additionally, fleet administrators can monitor task initiation and provide remote assistance if needed. The UI is designed to be intuitive, with clear prompts and progress indicators to guide the driver through the process seamlessly.

In Step 310, engine 200 can monitor performance of the first task, which can be respective to a time, activity associated with a task and/or location, for example, as discussed herein. That is, once a task is initiated, engine 200 can monitor (e.g., continuously, and/or periodically according to a criteria (e.g., time, for example)) execution of the task, whereby engine 200 can perform tracking key parameters such as, but not limited to, time taken, activities performed, location data, and the like, or some combination thereof. In some embodiments, engine 200 can process input from vehicle telematics, sensor readings, driver interactions with the UI, and/or external fleet management software integrations. Such real-time monitoring enables fleet managers to ensure that drivers adhere to established workflows and complete tasks efficiently. For example, if a driver is conducting a vehicle inspection, engine 200 can validate completion by checking timestamps, location coordinates, and input data accuracy. Any anomalies, such as excessive delays or skipped steps, can trigger alerts for further review. By continuously analyzing performance metrics, engine 200 provides capabilities to maintain workflow efficiency, and reduce operational risks and resource expenditure.

In Step 312, engine 200 can determine, based on the monitoring in Step 310, whether performance of the task is adequate to proceed to the next task. In some embodiments, such evaluation can be AI/ML based, as discussed above.

In some embodiments, such evaluation can involve cross-referencing expected completion criteria with actual execution data. For example, in some embodiments, if/when engine 200 detects discrepancies, such as incomplete checklists or missing data entries, engine 200 can prompt the driver for corrections before allowing workflow progression. Indeed, AI/ML-driven anomaly detection can be utilized to identify unusual task execution patterns that could indicate errors or inefficiencies. By way of example, if a workflow involves a safety inspection, engine 200 may compare recent inspection reports with historical data to detect inconsistencies.

Thus, by enforcing task validation, engine 200 ensures that workflows maintain high standards of accuracy and reliability. This step can be crucial in mission-critical applications, such as hazardous material transport or fleet safety inspections, where errors can lead to compliance violations or operational inefficiencies.

According to some embodiments, when the determination in Step 312 results in a task being determined to not be completed (e.g., a threshold satisfying number of operations of the task have not been met, for example), engine 200 can proceed to Step 314.

In Step 314, engine 200 can cause the storage of data/metadata related to the current status of the task in a database, and/or cause display of such information within an updated UI. For example, the UI for the driver can be updated to indicate that certain sub-tasks remain uncompleted. In another example, a fleet manager can be provided with an update that indicates the current status, and provides mechanisms for the manager to contact the driver to inquire about status/reasoning.

In some embodiments, Step 314 can involve prompting, via the UI, the driver to complete the task and/or reattempt the task. In some embodiments, engine 200 can employ employs real-time data validation to detect and flag performance issues, ensuring that all tasks meet compliance standards. In some embodiments, this can involve revisiting a vehicle inspection checklist, correcting documentation errors, and/or addressing flagged issues before proceeding. In cases where performance does not meet required standards after multiple attempts, engine 200 can escalate the issue by notifying the fleet manager. The notification can include, for example, automated reports detailing detected issues and recommended corrective actions. Such escalation mechanism ensures that critical tasks are not overlooked and that necessary interventions are made promptly. Fleet managers can then remotely assist the driver or dispatch support personnel as needed, ensuring that workflows remain efficient and compliant.

Turning back to Step 312, when the determination in Step 312 results in a task being determined to be completed (e.g., a threshold satisfying number of operations of the task have been met, for example), engine 200 can proceed to Step 316.

In Ste 316, similar to Step 314 discussed supra, the information related to the current status of the task (e.g., completed) and/or overall workflow status can be stored in a database, and/or provided via an updated UI. The updated UI can provide a new window, or new portion display within a displayed UI (to the driver and/or fleet manager) that provides a next task to be performed, as discussed herein.

In some embodiments, Step 316 can involve engine 200 automatically progressing to the next task in the workflow sequence (determined in Step 306). Such iterative process can continue until each task in the workflow sequence is determined to be completed (e.g., via Step 312).

In some embodiments, engine 200 can utilize predictive analytics to determine whether future tasks in the sequence need adjustments based on real-time conditions. For example, such AI/ML modeling, discussed supra. For example, if a scheduled refueling stop is deemed unnecessary based on recent fuel efficiency data, the workflow can be dynamically modified. By automating task transitions, engine 200 reduces manual intervention, allowing drivers to focus on execution rather than administrative tasks, and fleet managers to focus on resource allocation, rather than micro-managing each specific driver. The seamless transition between workflow steps ensures continuity and minimizes delays. Moreover, engine 200 can dynamically adjust workflows based on real-time conditions, such as rerouting tasks due to unforeseen events like traffic delays or equipment malfunctions, as discussed herein.

And, in Step 318, engine 200 can compile (e.g., generate or create) an electronic report that details the status of the tasks. Step 318 can be performed upon completion of Steps 314 and/or 316 prior to their recursive operation, as depicted in FIG. 3.

According to some embodiments, the generated electronic report can include information summarizing tasks (e.g., completed, ongoing, current, failed, next in queue, not yet completed or performed, and the like), performance metrics, and/or any flagged issues. Such reports aggregate structured data, including timestamps, geospatial tracking logs, sensor data, and driver interactions.

According to some embodiments, engine 200 can function to ensure that compliance-critical reports are formatted to meet regulatory requirements, allowing for seamless submission to oversight agencies (e.g. modify report from an initial or native format to another format for rendering and/or transmittal).

In some embodiments, fleet managers can access these reports via a centralized dashboard, gaining insights into workflow efficiency, driver performance, and fleet operations. Accordingly, engine 200's ability to generate real-time reports enhances transparency and accountability, enabling data-driven decision-making. Additionally, the reports can be integrated with external compliance systems, streamlining regulatory submissions and reducing administrative workload.

Accordingly, as discussed herein, via the steps of Process 300, engine 200 enhances fleet management efficiency, ensures compliance and optimizes workflow execution. The integration of event-driven triggers, real-time monitoring, AI/ML-based anomaly detection, and adaptive workflows enables fleets to operate seamlessly while maintaining high standards of safety and performance. The customizable nature of the workflow engine ensures that it can be tailored to diverse operational requirements, making it a versatile solution for modern fleet management challenges.

Indeed, the disclosed functionality of the instant framework (e.g., operations of engine 200) transforms fleet management from a reactive to a proactive compliance model. Instead of fleet managers spending extensive time tracking down incomplete documentation, the disclosed framework and its operation thereof ensures tasks are completed systematically and consistently. Reporting features provide fleet administrators with comprehensive insights, including detailed reports on workflow completion rates, error frequencies, and driver compliance metrics. This data-driven approach enables more effective operational management and continuous process improvement. Therefore, the framework's flexibility allows for implementation across various fleet sizes and operational contexts, from small local operators to large national transportation companies.

FIG. 6 is a schematic diagram illustrating a client device showing an example embodiment of a client device that can be used within the present disclosure. Client device 600 can include many more or less components than those shown in FIG. 6. However, the components shown are sufficient to disclose an illustrative embodiment for implementing the present disclosure. Client device 600 can represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 can optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 can be a liquid crystal display (LCD), gas plasma, light emitting diode (LED), or any other type of display used with a computing device. Display 654 can also include a touch sensitive screen arranged to receive input from an object such as a stylus or a digit from a human hand.

Keypad 656 can include any input device arranged to receive input from a user. Illuminator 658 can provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 can through other components, provide other information that can be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores can be employed to store information that describes various capabilities of Client device 600. The information can then be provided to another device based on any of a variety of events, including being sent as part of a header (e.g., index file of the HLS stream) during a communication, sent upon request, or the like. At least a portion of the capability information can also be stored on a disk drive or other storage medium (not shown) within Client device 600.

Applications 642 can include computer executable instructions which, when executed by Client device 600, transmit, receive, and/or otherwise process audio, video, images, and enable telecommunication with a server and/or another user of another client device. Applications 642 can further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements can include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors can be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors can be dual-core processor(s), dual-core mobile processor(s), and so forth.

Computer-related systems, computer systems, and systems, as used herein, include any combination of hardware and software. Examples of software can include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements can vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module can be stored on a computer readable medium for execution by a processor. Modules can be integral to one or more servers, or be loaded and executed by one or more servers. One or more modules can be grouped into an engine or an application.

One or more aspects of at least one embodiment can be implemented by representative instructions stored on a machine-readable medium which represents various logic within the processor, which when read by a machine causes the machine to fabricate logic to perform the techniques described herein. Such representations, known as “IP cores,” can be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure can be downloadable from a network, for example, a website, as a stand-alone product or as an add-in package for installation in an existing software application. For example, exemplary software specifically programmed in accordance with one or more principles of the present disclosure can also be available as a client-server software application, or as a web-enabled software application. For example, exemplary software specifically programmed in accordance with one or more principles of the present disclosure can also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure can be implemented in many manners and as such are not to be limited by the foregoing exemplary embodiments and examples. In other words, functional elements being performed by single or multiple components, in various combinations of hardware and software or firmware, and individual functions, can be distributed among software applications at either the client level or server level or both. In this regard, any number of the features of the different embodiments described herein can be combined into single or multiple embodiments, and alternate embodiments having fewer than, or more than, all of the features described herein are possible.

Functionality can also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that can be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications can be made to the elements and operations described above to obtain a result that remains within the scope of the systems and processes described in this disclosure.

What is claimed is:

1. A system comprising:
a vehicle telematics control unit operational within a vehicle management platform, the configured to:
identify information associated with a set of tasks, the set of tasks comprising event information as related to location and temporal parameters for each task in the set of tasks;
analyze, by a computational model, the identified information based at least in part on user information, the analysis comprising performing computational analysis of the user information based on the event information for each task in the set of tasks;
generate, based on the analysis, a time and location-based sequence, the sequence being an executable data structure comprising a set of controls that secures access to operations associated with a task in the set of tasks;
output, for display within a user interface (UI), electronic information associated with the time and location-based sequence; and
control, based at least in part on execution of the data structure, real-world movements of a vehicle via connectivity to at least a driving component of the vehicle.

2. The system of claim 1, wherein the information associated with the time and location-based sequence comprises a current task within the set of tasks.

3. The system of claim 2, wherein the vehicle telematics control unit is further configured to:
monitor activity of user equipment (UE) of the user; and
determine, based on analysis of the monitored activity, a status of the current tasks, the status indicating whether the current task is completed or ongoing.

4. The system of claim 3, wherein the vehicle telematics control unit is further configured to:
identify, within the time and location-based sequence, a next task when the status indicates the current task is completed; and
update the UI based on the event information for the next task.

5. The system of claim 1, wherein the vehicle telematics control unit is further configured to:
generate an electronic report, the report comprising interactive information related to operation of the set of tasks by the user.

6. The system of claim 1, wherein the vehicle telematics control unit is associated with a device operated by a fleet controller, wherein the vehicle telematics control unit is further configured to communicate the output to a device of the user.

7. The system of claim 1, wherein the vehicle telematics control unit is associated with the vehicle, the user being a driver of the vehicle.

8. The system of claim 1, wherein the set of controls are configured to restrict a sub-set of operations provided by an application until a criteria is satisfied, the criteria corresponding to completion of the current task.

9. The system of claim 1, wherein the time and location-based sequence comprises time and location information for completed performance of each of the set of tasks.

10. The system of claim 1, wherein the computation model comprises an artificial intelligence model.

11. A method comprising:
identifying, by an application, information associated with a set of tasks, the set of tasks comprising event information as related to location and temporal parameters for each task in the set of tasks;
analyzing, by the application, the identified information based at least in part on user information, the analysis comprising performing computational analysis of the user information based on the event information for each task in the set of tasks;
generating, by the application, based on the analysis, a time and location-based sequence, the sequence being an executable data structure comprising a set of controls that secures access to operations associated with a task in the set of tasks;
outputting, by the application, for display within a user interface (UI), electronic information associated with the time and location-based sequence.

12. The method of claim 11, wherein the information associated with the time and location-based sequence comprises a current task within the set of tasks, wherein the method further comprises:
monitoring activity of user equipment (UE) of the user; and
determining, based on analysis of the monitored activity, a status of the current tasks, the status indicating whether the current task is completed or ongoing.

13. The method of claim 12, further comprising:
identifying, within the time and location-based sequence, a next task when the status indicates the current task is completed; and
updating the UI based on the event information for the next task.

14. The method of claim 11, further comprising:
controlling, based at least in part on execution of the data structure, real-world movements of a vehicle via connectivity to at least a driving component of the vehicle.

15. The method of claim 11, further comprising:
generating an electronic report, the report comprising interactive information related to operation of the set of tasks by the user.

16. The method of claim 11, wherein the application is executed by a vehicle telematics control unit associated with a device operated by a fleet controller, wherein the application further communicates the output to a device of the user.

17. The method of claim 11, wherein the application is executed by a vehicle telematics control unit associated with a vehicle, the user being a driver of the vehicle.

18. The method of claim 11, wherein the set of controls are configured to restrict a sub-set of operations provided by the application until a criteria is satisfied, the criteria corresponding to completion of the current task.

19. The method of claim 11, wherein the time and location-based sequence comprises time and location information for completed performance of each of the set of tasks.

20. A non-transitory computer-readable storage medium tangibly encoded with computer-executable instructions that when executed by a processor, perform a method comprising:
identifying, by an application, information associated with a set of tasks, the set of tasks comprising event information as related to location and temporal parameters for each task in the set of tasks;
analyzing, by the application, the identified information based at least in part on user information, the analysis comprising performing computational analysis of the user information based on the event information for each task in the set of tasks;
generating, by the application, based on the analysis, a time and location-based sequence, the sequence being an executable data structure comprising a set of controls that secures access to operations associated with a task in the set of tasks;
outputting, by the application, for display within a user interface (UI), electronic information associated with the time and location-based sequence.
